(19) United States
(12) Patent Application Publication
(10) Pub. No.: US 2025/0298696 A1
(43) Pub. Date: Sep. 25, 2025

(54) NON-DISRUPTIVE FAULT RECOVERY

(71) Applicant: QUALCOMM Incorporated, San Diego, CA (US)

(72) Inventors: Dinesh Kumar CHOUDHARY, Tonk (IN); Chandan AGARWALLA, San Diego, CA (US); Maulik SHAH, Hyderabad (IN); Nirav Narendra DESAI, Hyderabad (IN); Raja Simha REVANURU, Hyderabad (IN); Srinivas Rao LENGAMANENI, Hyderabad (IN)

(21) Appl. No.: 18/609,330

(22) Filed: Mar. 19, 2024

(51) Int. Cl. G06F 11/07; G06F 11/14

(52) U.S. Cl. CPC G06F 11/1441; G06F 11/0724; G06F 11/0772; G06F 11/0778; G06F 11/2028; G06F 11/203; G06F 11/2035; G06F 11/2048

(57) ABSTRACT

Certain aspects of the present disclosure provide techniques and apparatus for non-disruptive fault handling. Embodiments include determining a fault associated with a processor in a first processor cluster of a system on chip (SoC) comprising the first processor cluster and a second processor cluster. Embodiments include, without resetting the SoC, performing, based on the fault, a fault handling process comprising halting processors running in the first processor cluster, performing a reset operation for at least a portion of the first processor cluster, and resuming the processors that were halted in the first processor cluster. Embodiments include, after performing the fault handling process, performing one or more actions using the processor in the first processor cluster.

### INTRODUCTION

Aspects of the present disclosure relate to fault recovery for a system on chip (SoC).

Computing devices are ubiquitous. Some computing devices are portable such as mobile phones, tablets, and laptop computers. As the functionality of such portable computing devices increases, the computing or processing power required and the data storage capacity to support such functionality also increases. In addition to the primary function of these devices, many include elements that support peripheral functions. For example, a cellular telephone may include the primary function of enabling and supporting cellular telephone calls and the peripheral functions of a still camera, a video camera, global positioning system (GPS) navigation, web browsing, sending and receiving emails, sending and receiving text messages, push-to-talk capabilities, etc. Many of these portable devices include an SoC to enable one or more primary and peripheral functions on the specific device.

A SoC generally includes multiple central processing unit (CPU) cores embedded in an integrated circuit or chip and coupled to a local bus. The CPU cores may further be arranged into one or more computing clusters. The SoC may further generally include hardware components and other processors.

The complexity of SoC architectures continues to increase as new types of functionality such as on-demand artificial intelligence (AI) become more common on such devices. For example, such complexity may include increasing numbers of cores, optimized caches, rich feature set firmware independently running, different clusters/subsystems working in tandem, and many other techniques to achieve increased performance. Along with such complexities comes additional opportunities for different types of stability faults to occur in the SoC. For example, with increased complexities, the SoC may be exposed to a larger number of stability faults, most of which are likely to result in a reset of the entire SoC.

### BRIEF SUMMARY

Certain aspects provide a method, comprising: determining a fault associated with a processor in a first processor cluster of a system on chip (SoC) comprising the first processor cluster and a second processor cluster; without resetting the SoC, performing, based on the fault, a fault handling process comprising: halting processors running in the first processor cluster; performing a reset operation for at least a portion of the first processor cluster; and resuming the processors that were halted in the first processor cluster; and after performing the fault handling process, performing one or more actions using the processor in the first processor cluster.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example computing environment for non-disruptive fault recovery according to various aspects of the present disclosure.

FIG. 2 illustrates an example pipeline for fault recovery according to various aspects of the present disclosure.

FIG. 3 illustrates an example pipeline for non-disruptive fault recovery according to various aspects of the present disclosure.

FIG. 4 illustrates an example pipeline for non-disruptive firmware fault recovery according to various aspects of the present disclosure.

FIG. 5 is a flow diagram depicting an example method for non-disruptive firmware fault recovery according to various aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for non-disruptive fault recovery.

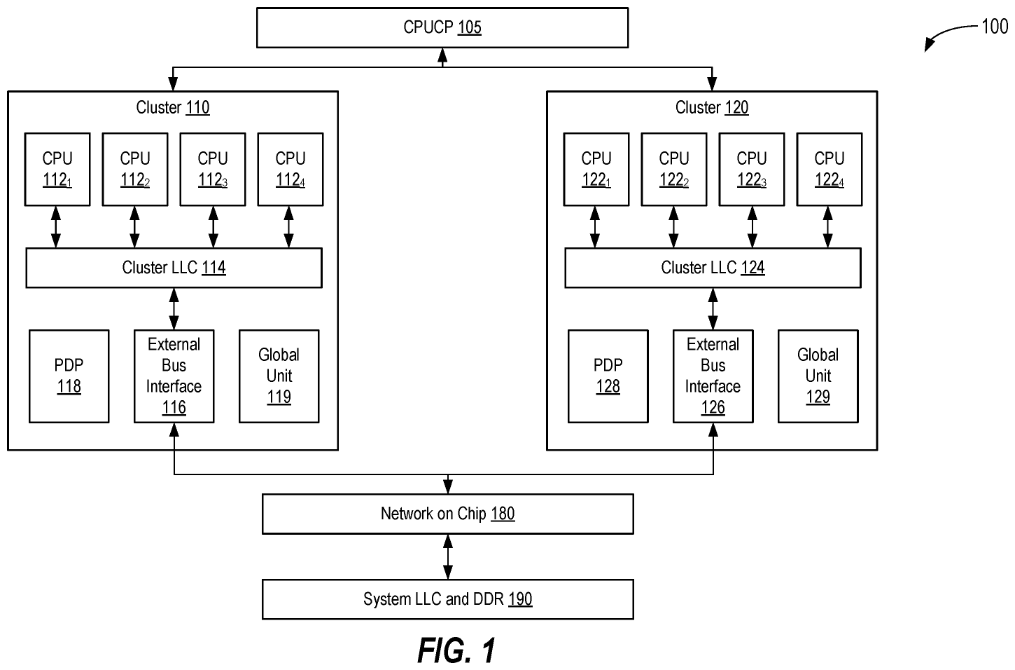

In a system on chip (SoC) many types of faults may occur. For example, as described in more detail below with respect to FIG. 1, an SoC may include multiple processor clusters running multiple processors, and faults may occur with any of these processors and/or related components in the SoC. Many faults, such as those that cause a processor to hang, trigger an alert at a central processing unit (CPU) control processor (CPUCP) of the SoC for centralized fault handling.

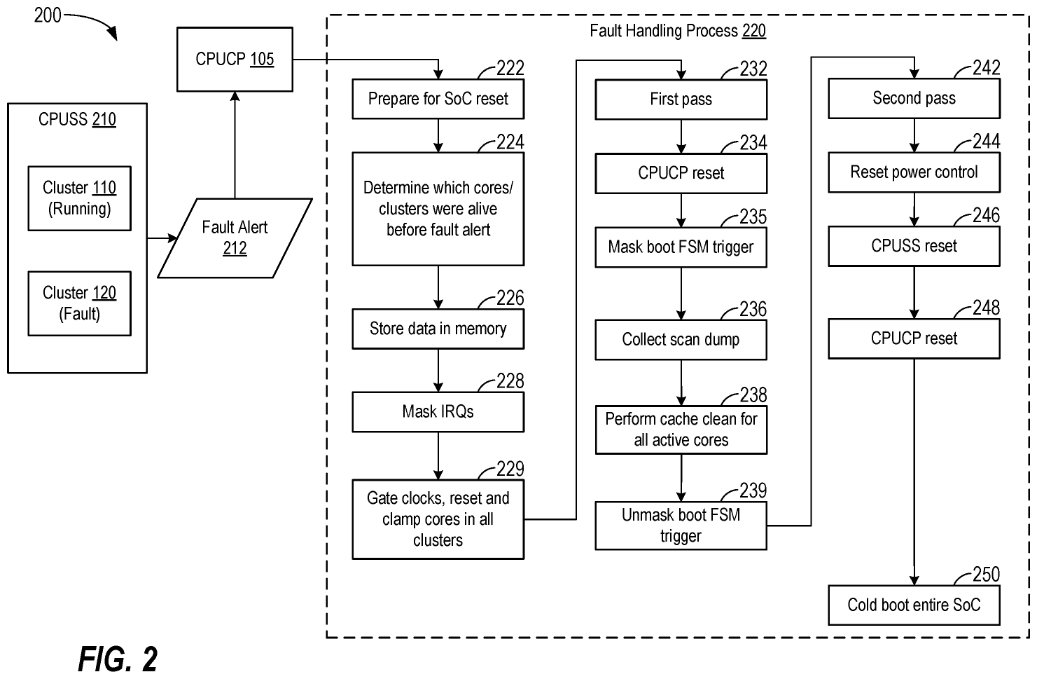

Existing techniques for centralized fault handling on an SoC involve a reset of the entire SoC. For example, as described below with respect to FIG. 2, such a fault handling process may involve steps such as performing resets for all processor cores in all clusters (e.g., even those without a fault), resetting the CPUCP, and resetting the entire SoC. However, these fault handling techniques can be disruptive to the entire SoC.

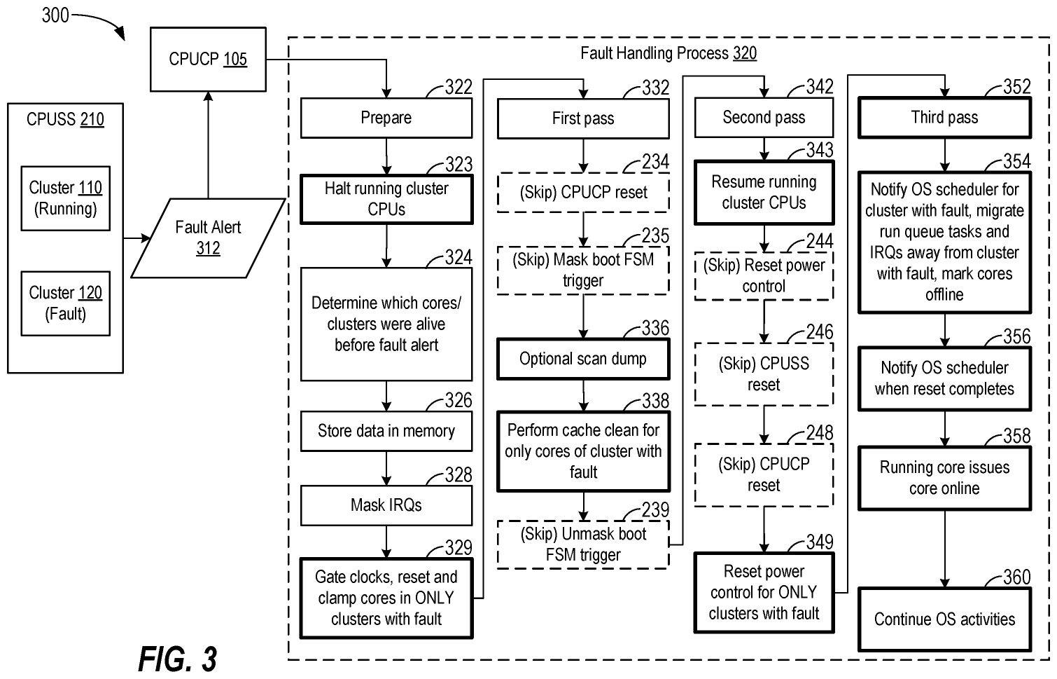

Aspects described herein provide non-disruptive (or less disruptive) fault recovery techniques that do not require resetting the entire SoC or resetting processor cores in clusters not experiencing a fault. As described in more detail below with respect to FIG. 3, a non-disruptive fault handling process may involve, among other steps, halting CPUs in running clusters (e.g., those without a fault), performing a reset operation only for processor cores in the cluster experiencing a fault, resuming the CPUs in the running clusters, and then performing OS-level activities to allow operations to continue on all clusters without resetting the SoC.

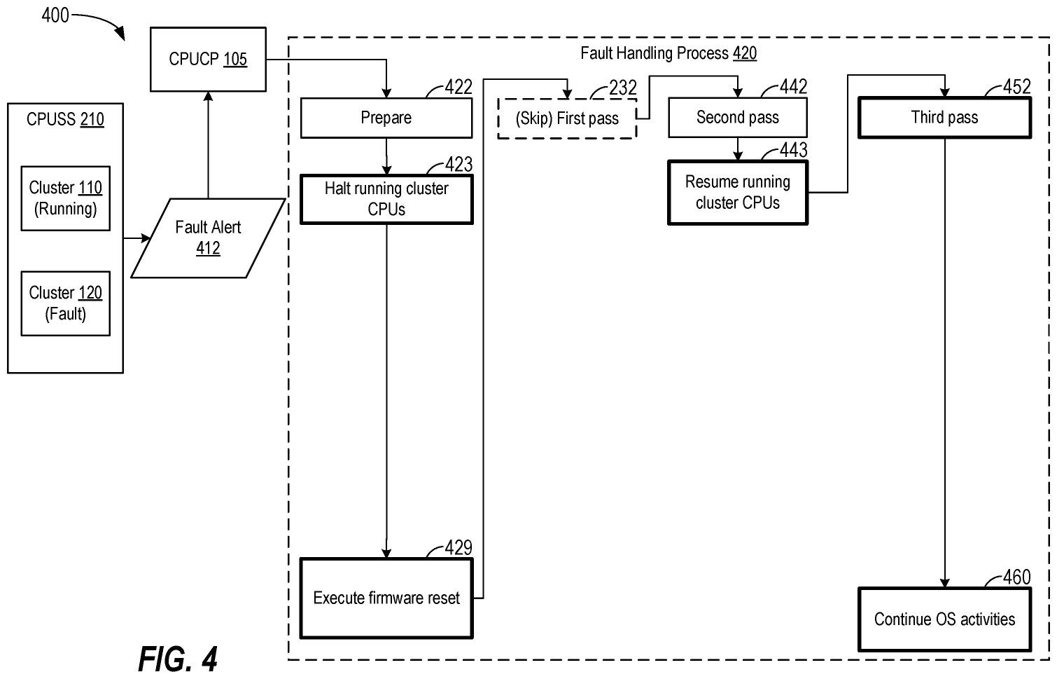

Certain aspects provide a further streamlined fault recovery process for firmware-specific fault. For example, as described in more detail below with respect to FIG. 4, when a firmware fault occurs, a non-disruptive fault handling process may involve halting CPUs in running clusters, performing a firmware reset in the cluster experiencing a fault, resuming the CPUs in the running clusters, and continuing operations on all clusters without resetting the SoC.

Aspects of the present disclosure provide multiple technical improvements with respect to existing fault recovery techniques. For example, by avoiding a reset of the entire SoC, fault handling techniques described herein reduce the amount of disruption to operations on the SoC when recovering from a fault, thereby improving the functioning of the SoC. Furthermore, by performing reset operations only on processor cores in clusters experiencing a fault, techniques described herein may help avoid the additional disruption and computing resource utilization that would otherwise be caused by performing resets and other fault handling operations on processor cores in clusters not experiencing a fault, and thereby improve the functioning of the SoC. Additionally, by further streamlining the fault recovery process for firmware-specific faults through avoiding additional fault recovery logic in such cases, aspects described herein may further avoid disruption, which may improve computing resource utilization and reduce latency, and thereby further improve the functioning of the SoC.

### Example Computing Environment for Non-Disruptive Fault Handling

FIG. 1 illustrates an example computing environment 100 in which non-disruptive fault handling may be performed according to various aspects of the present disclosure. The computing environment 100 represents an SoC, and is included as an example, and techniques described herein may be performed in other types of computing environments. The computing environment 100 includes two clusters 110 and 120 of processors, which are connected to a CPU control processor (CPUCP) 105 that performs aspects of fault handling techniques described herein. CPUCP 105 may, for example, be a primary or most important processing unit of the SoC, and may perform control functionality for all processors of the SoC. Power management functionality related to clusters 110 and 120 at the cluster level may be coordinated by CPUCP 105.

Cluster 110 and cluster 120 each includes a plurality of CPUs 112₁₋₄ and 122₁₋₄, respectively, each of which is connected to a respective cluster last level cache (LLC) 114 and 124. Each of CPUs 112₁₋₄ and 122₁₋₄ generally includes a layer 1 (L1) data cache and an instruction cache that is private to the particular CPU. A cluster LLC 114 or 124 generally comprises a last level cache for processor information across the CPUs of a given cluster. For example, cluster LLCs 114 and 124 may be layer 2 (L2) caches.

Clusters 110 and 120 further comprise global units 119 and 129, each of which comprises a block of power state machines and/or other cluster specific hardware (e.g., interrupt controllers) for coordinating the respective cluster.

Clusters 110 and 120 further comprise power and debug processors (PDPs) 118 and 128, each of which is a co-processor for a specific set of cores or particular cluster, and includes firmware that runs a complex set of features related to power management and deubugging for the respective cluster.

Clusters 110 and 120 further comprise external bus interfaces 116 and 126, which serve as a communication interface between the respective cluster and the network on chip (NOC) 180 and system LLC and double data rate (DDR) memory 190.

NOC 180 provides coherency for clusters 110 and 120 and provides a pathway to system LLC and DDR 190. System LLC and DDR provides a last level cache for the SoC (e.g., across all clusters) and memory for the SoC.

Various faults can occur in computing environment 100, such as within individual components of clusters 110 and 120. For example, a fault can occur locally at an individual CPU 112₁₋₄ and 122₁₋₄, at a cluster LLC 114 or 124, a PDP 118 or 128, or a global unit 119 or 129. Additionally, communications faults can occur between various components, such as a mailbox failure between a CPU within one of clusters 110 and 120 and CPUCP 105. Centralized faults can also occur, such as an NOC 180 timer or stuck transaction issue, bit flips or memory corruptions at LLC or DDR 190, and/or the like. Faults can be the result of hardware, software, or firmware issues. Techniques for handling such faults are described below with respect to FIGS. 2-6.

### Example Pipeline for Fault Recovery

FIG. 2 is a diagram depicting an example pipeline 200 for fault recovery. In particular, pipeline 200 represents a process for handling a fault detected in a processor cluster.

Pipeline 200 includes CPUCP 105 of FIG. 1 and a CPU sub-system (CPUSS) 210 that includes clusters 110 and 120 of FIG. 1. CPUSS 210 may include a monitoring component, such as a watchdog component, that monitors functioning of components within CPUSS 210, such as processors and other components in clusters 110 and 120. A fault alert 212 is generated by CPUSS 210, such as by a monitoring component, and provided to CPUCP 105. Fault alert 212 may be a notification of a fault detected within cluster 120. In an example, fault alert 212 is a “watchdog bite” from a watchdog component of CPUSS 210. In the depicted example, a fault has occurred at cluster 120, but no fault has occurred at cluster 110. Fault alert 212 may, for example, indicate a processor hang event of a particular CPU within cluster 120.

CPUCP 105 initiates a fault handling process 220 based on fault alert 212. Fault handling process 220 begins with preparing for a SOC reset at step 222. At step 224, a determination is made of which cores and/or clusters were alive before the fault alert, such as by reading control and status register (CSR) data and/or other information about statuses of components. At step 226, data in memory is stored (e.g., the contents of data memory (DMEM) for running cores may be stored in persistent storage). At step 228, interrupt requests (IRQs) are masked.

At step 229, for all cores in all cluster, clocks are gated and the cores are reset and clamped. For example, step 229 may involve gating clocks and resetting and clamping all CPUs in cluster 120, which experienced the fault, as well as cluster 110, which did not experience a fault.

At step 232, a first pass begins (e.g., representing a pass or phase of the fault handling process 220). At step 234, a CPUCP reset is performed. For example, CPUCP 105 may be completely reset at step 234.

At step 235, a boot finite state machine (FSM) trigger is masked. At step, 236, a scan dump is collected (e.g., results of a scan are retrieved). At step 238, a cache clean is performed for all active cores (e.g., all CPUs that are currently running on all clusters). At step 239 the boot FSM trigger is unmasked.

At step 242, a second pass begins. At step 244, a power control reset is performed. At step 246, a CPUSS reset is performed (e.g., the entire CPUSS 210 is reset). At step 248, another CPUCP reset is performed (e.g., a reset of CPUCP 105 is performed again).

Finally, at step 250, a cold boot of the entire SoC is performed.

The fault handling process 220 depicted in FIG. 2 includes various points of disruption that add costs in terms of time and computing resource utilization and unavailability. Accordingly, techniques described herein provide streamlined, non-disruptive fault handling processes that minimize the impact to the SoC, and particularly to clusters not experiencing a fault, as described below.

### Example Pipeline for Non-Disruptive Fault Recovery

FIG. 3 is a diagram depicting an example pipeline 300 for non-disruptive fault recovery. Pipeline 300 includes some aspects of pipeline 200 of FIG. 2, while removing some aspects of pipeline 200 of FIG. 2 and adding additional aspects. Pipeline 300 represents a streamlined, non-disruptive version of pipeline 200 of FIG. 2.

Pipeline 300 includes CPUCP 105 of FIG. 1 and a CPUSS 210 of FIG. 2, including clusters 110 and 120 of FIGS. 1 and 2. A fault alert 312 is generated by CPUSS 210, such as by a monitoring component, and provided to CPUCP 105. Fault alert 212 may be a notification of a fault detected within cluster 120. In the depicted example, a fault has occurred at cluster 120, but no fault has occurred at cluster 110. Fault alert 212 may, for example, indicate a processor hang event of a particular CPU within cluster 120 (e.g., the same sort of fault indicated by fault alert 212 of FIG. 2).

CPUCP 105 initiates a fault handling process 320 based on fault alert 312. Fault handling process 320 begins at step 222 with preparing for fault handling. Rather than preparing for an entire SoC reset, step 322 may involve preparing for a more streamlined fault handling process.

At step 323 (which is an additional step not included in fault handling process 220 of FIG. 2), all running cluster CPUs are halted. For example, step 323 may involve halting all running CPUs on clusters 110 and 120.

At step 324 (which may correspond to step 224 of FIG. 2), a determination is made of which cores and/or clusters were alive before the fault alert, such as by reading control and status register (CSR) data and/or other information about statuses of components. At step 326 (which may correspond to step 226 of FIG. 2), data in memory is stored (e.g., the contents of data memory (DMEM) for running cores may be stored in persistent storage). At step 328 (which may correspond to step 228 of FIG. 2), interrupt requests (IRQs) are masked.

At step 329 (which may be considered a streamlined version of step 229 of FIG. 2), for cores in only clusters with a fault (e.g., in this case, cluster 120), clocks are gated and the cores are reset and clamped. For example, step 329 may involve gating clocks and resetting and clamping all CPUs in cluster 120, which experienced the fault, but not for any CPUs in cluster 110, which did not experience a fault.

At step 332, a first pass begins. In fault handling process 320, steps 234 and 235 of fault handling process 220 of FIG. 2 are skipped. Thus, in fault handling process 320, no CPUCP reset is performed and the boot FSM trigger is not masked, thereby reducing disruptions, time, and computing resource utilization and unavailability.

At step 336 (which may be considered a streamlined version of step 236 of FIG. 2), a scan dump is optionally collected. By contrast, step 236 of FIG. 2 involves always collecting a scan dump rather than optionally collecting a scan dump.

At step 338 (which may be considered a streamlined version of step 238 of FIG. 2), a cache clean is performed only for the cores of clusters with a fault (e.g., cluster 120). By contrast, step 238 of FIG. 2 involves performing a cache clean for cores of all clusters, even those not experiencing a fault.

In fault handling process 320, step 239 of fault handling process 220 of FIG. 2 is skipped. In fault handling process 320, the boot FSM trigger does not need to be unmasked because it was not masked.

At step 342, a second pass begins. At step 343 (which is an additional step not included in fault handling process 220 of FIG. 2), all running cluster CPUs are resumed. For example, all of the CPUs that were halted at step 323 may be resumed at step 343.

In fault handling process 320, steps 244, 246, and 248 of fault handling process 220 of FIG. 2 are skipped. Thus, in fault handling process 320, no power control reset is performed, no CPUSS reset is performed, and no CPUCP reset is performed, thereby reducing disruptions, time, and computing resource utilization and unavailability.

At step 349 (which may be a streamlined version of step 244 of FIG. 2), a power control reset is performed only for clusters with a fault (e.g., cluster 120). By contrast, step 244 of FIG. 2 involves performing a power control reset for all clusters, even those not experiencing a fault.

At step 352, a third pass begins. The third pass is an added pass that is not included in fault handling process 220 of FIG. 2. At step 354, a notification is sent to the operating system (OS) scheduler for clusters with a fault (e.g., cluster 120), run queue tasks and IRQs are migrated away from clusters with a fault (e.g., cluster 120), and the cores of clusters with a fault (e.g., cluster 120) are marked as being offline.

At step 356, the OS scheduler is notified when the reset completes (e.g., when the core resets performed at step 329 and/or the power control reset performed at step 349 is complete). For example, the OS scheduler may be notified about the cores' states from an earlier running state (e.g., before fault) to the present state involving a reset, such as to enable the OS scheduler to migrate away tasks scheduled on these cores. In some cases, such a notification occurs at or after step 349.

At step 358, one or more running cores issue a “core online” message for cores that were marked as offline at step 354.

At step 360, OS activities continue (e.g., on all CPUs of all clusters, including clusters 110 and 120), as the fault has been handled.

Notably, fault handling process 320 does not involve a complete SoC reset, a CPUCP reset, a CPUSS reset, or a reset of any CPUs in any clusters not experiencing a fault. Furthermore, fault handling process 320 streamlines other aspects, such as avoiding gating clocks for clusters not experiencing a fault, avoiding collecting a scan dump in some cases, avoiding masking and unmasking the boot FSM trigger, and avoiding a reset of the power control for clusters not experiencing a fault. Accordingly, fault handling process 320 is significantly less disruptive than fault handling process 220 of FIG. 2, while still safely and efficiently handling the fault.

For example, if a CPU 122 of cluster 120 of FIG. 1 hangs, fault alert 312 may be a watchdog IRQ issued to CPUCP 105 from the CPU 122. In another example, if global unit 129 of cluster 120 of FIG. 1 experiences a hang (e.g., relating to a CPU), fault alert 312 may be issued to CPUCP 105 from the global unit, which may detect a hang in a hardware context save or restore, such as during a CPU power up or power down. In yet another example, a communication failure may occur between a CPU within cluster 120 and PDP 128 of FIG. 1 within cluster 120, such as a mailbox hang event, and PDP 128 of FIG. 1 may detect the hang event and communicate fault alert 312 to CPUCP 105. In such cases, CPUCP 105 runs fault handling process 320, which includes, among other operations, issuing a reset only to cluster 120 (and not to cluster 110), flushing L1 and L2 caches of cluster 120 (and not of cluster 110), notifying cluster 110 of the fault handling process, migrating run queues and IRQs away from cluster 120 (e.g., to cluster 110), and cluster 110 marking cluster 120 cores as offline and then issuing a fresh online message to cluster 120.

### Example Pipeline for Non-Disruptive Firmware Fault Recovery

FIG. 4 is a diagram depicting an example pipeline 400 for non-disruptive fault recovery. Pipeline 400 includes some aspects of pipeline 200 of FIG. 2 and pipeline 300 of FIG. 3, while removing some aspects of these pipelines and adding additional aspects. Pipeline 400 represents a streamlined, non-disruptive fault handling pipeline for firmware-specific faults.

Pipeline 400 includes CPUCP 105 of FIG. 1 and a CPUSS 210 of FIGS. 2 and 3, including clusters 110 and 120 of FIGS. 1-3. A fault alert 412 is generated by CPUSS 210, such as by a monitoring component, and provided to CPUCP 105. Fault alert 412 may be a notification of a firmware fault detected within cluster 120, such as a fault within PDP 128 of FIG. 1. In the depicted example, a fault has occurred at cluster 120, but no fault has occurred at cluster 110. Fault alert 412 may, for example, indicate a firmware fault at a PDP or other component within cluster 120.

CPUCP 105 initiates a fault handling process 420 based on fault alert 412. Fault handling process 420 begins at step 422 with preparing for fault handling. Rather than preparing for an entire SoC reset, step 422 may involve preparing for a more streamlined fault handling process.

At step 423, all running cluster CPUs are halted. For example, step 423 may involve halting all running CPUs on clusters 110 and 120.

At step 429, a firmware reset is executed (e.g., the firmware experiencing the failure may be reset).

Method 400 begins at block 405, with accessing a value encoded with a sign bit in a machine learning model.

Step 232 of FIG. 2 is skipped in fault handling process 420, thereby skipping all steps in the first pass of either fault handling process 220 of FIG. 2 or fault handling process 320 of FIG. 3.

At step 442, a second pass is begun. At step 443, all running cluster CPUs are resumed. For example, all of the CPUs that were halted at step 423 may be resumed at step 343. All remaining steps in the second passes of fault handling process 220 of FIG. 2 and fault handling process 320 of FIG. 3 are skipped.

At step 452, a third pass is begun. At step 460, OS activities continue (e.g., on all CPUs of all clusters, including clusters 110 and 120), as the fault has been handled.

Notably, fault handling process 420 does not involve a complete SoC reset, a CPUCP reset, a CPUSS reset, or a reset of any CPUs in any clusters. Furthermore, fault handling process 420 streamlines other aspects, such as avoiding gating clocks for clusters, avoiding collecting a scan dump, avoiding masking and unmasking the boot FSM trigger, and avoiding a reset of the power control for any clusters. Additionally, fault handling process 420 avoids masking and unmasking any IRQs, performing any cache cleans, notifying the OS scheduler of any events, migrating run queue tasks and IRQs away from any clusters, marking any cores as offline, or issuing any core online messages. Accordingly, fault handling process 420 is significantly less disruptive for handling firmware faults than fault handling process 220 of FIG. 2 or even fault handling process 320 of FIG. 3, while still safely and efficiently handling the fault.

For example, if PDP 128 of cluster 120 of FIG. 1 hangs (e.g., as a result of a firmware issue), fault alert 312 may be a watchdog IRQ issued to CPUCP 105 from a watchdog component associated with the PDP 128 of FIG. 1. In another example, a communication failure may occur between a CPU within cluster 120 and PDP 128 of FIG. 1 within cluster 120, such as a mailbox hang event that results from a firmware issue on the PDP side, and the CPU (or another component) may detect the hang event and communicate fault alert 312 to CPUCP 105. In such cases, because the fault is the result of a firmware issue, CPUCP 105 runs fault handling process 420, which includes, among other operations, halting CPUs in the cluster associated with the fault (e.g., cluster 120), issuing a PDP reset only for the PDP experiencing the firmware issue (e.g., PDP 128 of FIG. 1), and resuming the CPUs in the cluster associated with the fault.

### Example Method for Non-Disruptive Fault Recovery

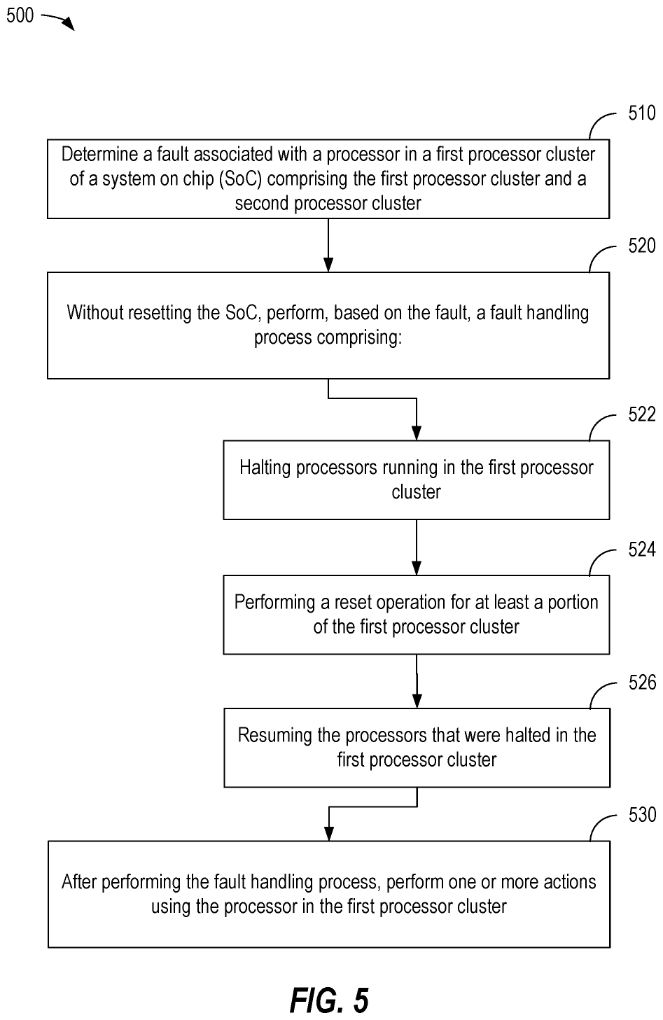

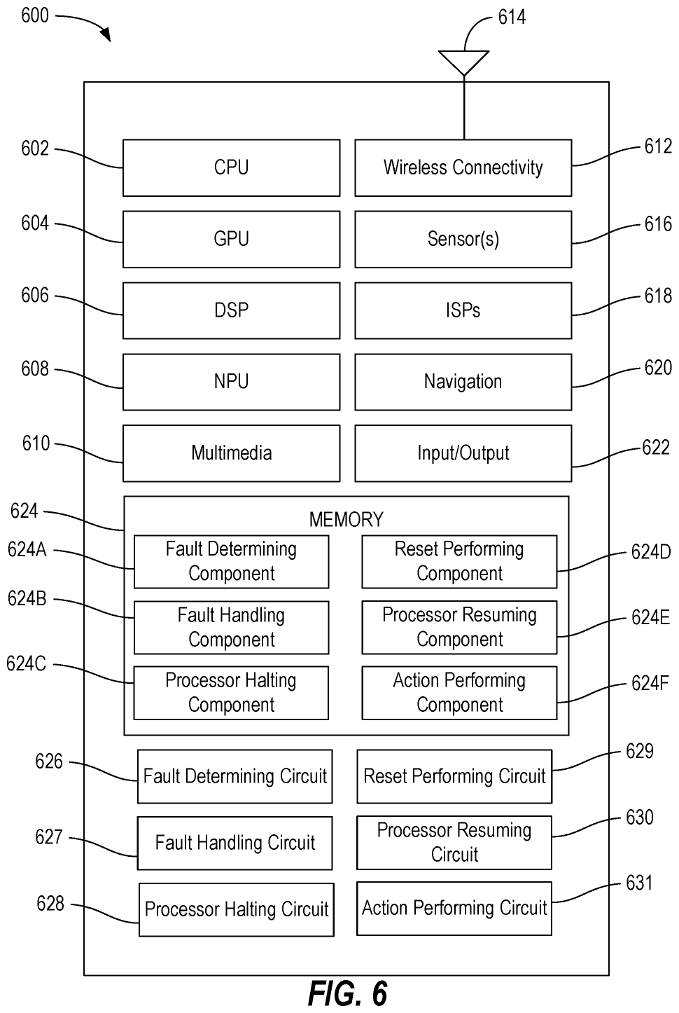

FIG. 5 is a diagram depicting an example method 500 for non-disruptive fault handling, according to various aspects of the present disclosure. For example, method 500 may be performed by one or more components of computing environment 100 of FIG. 1 and/or by a processing system such as processing system 600 of FIG. 6, described below. Method 500 may relate to one or more of pipeline 300 of FIG. 3 and pipeline 400 of FIG. 4.

Method 500 begins at block 510, with determining a fault associated with a processor in a first processor cluster of a system on chip (SoC) comprising the first processor cluster and a second processor cluster.

In some aspects, the determining of the fault comprises receiving a message from a performance monitoring component on the first cluster.

Method 500 continues at block 520, with, without resetting the SoC, performing, based on the fault, a fault handling process.

The fault handling process continues at block 522, with halting processors running in the first processor cluster.

The fault handling process continues at block 524, with performing a reset operation for at least a portion of the first processor cluster.

The fault handling process continues at block 526, with resuming the processors that were halted in the first processor cluster.

Method 500 continues at block 530, with after performing the fault handling process, performing one or more actions using the processor in the first processor cluster.

In some aspects, the fault comprises a processor hang event, and wherein the fault handling process further comprises masking interrupts for the first processor cluster.

In certain aspects, the reset operation comprises resetting and clamping one or more processor cores in the first processor cluster. In some aspects, the reset operation further comprises gating clocks for the one or more processor cores in the first processor cluster.

In some aspects, the fault handling process further comprises performing a cache clean for the processor in the first processor cluster.

In certain aspects, the fault handling process does not comprise resetting a central processing unit control processor (CPUCP) of the SoC.

In some aspects, the fault handling process further comprises collecting a scan dump.

In certain aspects, the fault handling process further comprises resetting power control for the first processor cluster and not for the second processor cluster.

In some aspects, the fault handling process further comprises migrating run queue tasks and interrupts away from the first processor cluster.

In certain aspects, the fault handling process further comprises marking one or more cores of the first processor cluster as offline.

In some aspects, the fault handling process further comprises notifying an operating system (OS) scheduler for the first processor cluster that the fault handling process is being performed. In certain aspects, the fault handling process further comprises notifying the OS scheduler for the first processor cluster that the reset operation is complete.

In some aspects, the fault comprises a firmware fault, and the reset operation comprises executing a firmware reset in the first processor cluster.

Method 500 allows for a fault to be recovered from in an SoC with minimal disruption, minimal time, and minimal computing resource utilization.

### Example Processing System for Non-Disruptive Fault Handling

In some aspects, the workflows, techniques, and methods described with reference to FIGS. 1-5 may be implemented on one or more devices or systems. FIG. 6 depicts an example processing system 600 configured to perform various aspects of the present disclosure, including, for example, the techniques and methods described with respect to FIGS. 1-5. In some aspects, the processing system 600 may correspond to an SoC. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as an SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a fault detecting component 624A, a fault handling component 624B, a processor halting component 624C, a reset performing component 624D, a processor resuming component 624E, and an action performing component 624F. Though depicted as discrete components for conceptual clarity in FIG. 6, the illustrated components (and others not depicted) may be collectively or individually implemented in various aspects.

The processing system 600 further comprises a fault detecting circuit 626, a fault handling circuit 627, a processor halting circuit 628, a reset performing circuit 629, a processor resuming circuit 630, and an action performing circuit 631. The depicted circuits, and others not depicted, may be configured to perform various aspects of the techniques described herein.

For example, the fault detecting component 624A and/or the fault detecting circuit 626 may be used to detect a fault within an SoC (e.g., within a first processor cluster), as discussed above with respect to fault alert 212 of FIG. 2, fault alert 312 of FIG. 3, fault alert 412 of FIG. 4, and/or block 510 of FIG. 5.

The fault handling component 624B and/or the fault handling circuit 627 may be used to perform a fault handling process in response to the fault without resetting the SoC, as described above with respect to fault handling process 220 of FIG. 2, fault handling process 320 of FIG. 3, fault handling process 420 of FIG. 4, and/or block 520 of FIG. 5. The processor halting component 624C and/or the processor halting circuit 628 may be used to halt one or more running processors, as described above with respect to step 323 of FIG. 3, step 423 of FIG. 4, and/or block 522 of FIG. 5. The reset performing component 624D and/or the reset performing circuit 629 may be used to perform a reset operation for at least a portion of the first processor cluster, as described above with respect to step 329 of FIG. 3, step 429 of FIG. 4, and/or block 524 of FIG. 5. The processor resuming component 624E and/or the processor resuming circuit 630 may be used to resume one or more processors, as described above with respect to step 343 of FIG. 3, step 443 of FIG. 4, and/or block 526 of FIG. 5. The action performing component 624F and/or the action performing circuit 631 may be used to perform one or more actions in the SoC after completing the fault recovery process, as described above with respect to step 360 of FIG. 3, step 460 of FIG. 4, and/or block 530 of FIG. 5.

Though depicted as separate components and circuits for clarity in FIG. 6, the fault detecting circuit 626, the fault handling circuit 627, the processor halting circuit 628, the reset performing circuit 629, the processor resuming circuit 630, and the action performing circuit 631 may collectively or individually be implemented in other processing devices of the processing system 600, such as within the CPU 602, the GPU 604, the DSP 606, the NPU 608, and the like. For example, the fault detecting circuit 626, the fault handling circuit 627, the processor halting circuit 628, the reset performing circuit 629, the processor resuming circuit 630, and the action performing circuit 631 may implemented via one or more instructions in an instruction set of the CPU 602, the GPU 604, the DSP 606, the NPU 608, or the like.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

Implementation examples are described in the following numbered clauses:

Clause 1: A method for system fault handling, comprising: determining a fault associated with a processor in a first processor cluster of a system on chip (SoC) comprising the first processor cluster and a second processor cluster; without resetting the SoC, performing, based on the fault, a fault handling process comprising: halting processors running in the first processor cluster; performing a reset operation for at least a portion of the first processor cluster; and resuming the processors that were halted in the first processor cluster; and, after performing the fault handling process, performing one or more actions using the processor in the first processor cluster.

Clause 2: The method of Clause 1, wherein the fault comprises a processor hang event, and wherein the fault handling process further comprises masking interrupts for the first processor cluster.

Clause 3: The method of Clause 2, wherein the reset operation comprises resetting and clamping one or more processor cores in the first processor cluster.

Clause 4: The method of any one of Clause 2-3, wherein the fault handling process further comprises performing a cache clean for the processor in the first processor cluster.

Clause 5: The method of any one of Clause 2-4, wherein the fault handling process does not comprise resetting a central processing unit control processor (CPUCP) of the SoC.

Clause 6: The method of any one of Clause 2-5, wherein the fault handling process further comprises collecting a scan dump.

Clause 7: The method of any one of Clause 2-6, wherein the fault handling process further comprises resetting power control for the first processor cluster and not for the second processor cluster.

Clause 8: The method of any one of Clause 2-7, wherein the fault handling process further comprises migrating run queue tasks and interrupts away from the first processor cluster.

Clause 9: The method of any one of Clause 2-8, wherein the fault handling process further comprises marking one or more cores of the first processor cluster as offline.

Clause 10: The method of any one of Clause 2-9, wherein the fault handling process further comprises notifying an operating system (OS) scheduler for the first processor cluster that the fault handling process is being performed.

Clause 11: The method of Clause 10, wherein the fault handling process further comprises notifying the OS scheduler for the first processor cluster that the reset operation is complete.

Clause 12: The method of any one of Clause 1-11, wherein the fault comprises a firmware fault, and wherein the reset operation comprises executing a firmware reset in the first processor cluster.

Clause 13: A processing system comprising: one or more memories comprising processor-executable instructions; and one or more processors configured to execute the processor-executable instructions and cause the processing system to: determine a fault associated with a processor in a first processor cluster of a system on chip (SoC) comprising the first processor cluster and a second processor cluster; without resetting the SoC, performing, based on the fault, a fault handling process comprising: halt processors running in the first processor cluster; perform a reset operation for at least a portion of the first processor cluster; and resume the processors that were halted in the first processor cluster; and, after performing the fault handling process, perform one or more actions using the processor in the first processor cluster.

Clause 14: The processing system of Clause 13, wherein the fault comprises a processor hang event, and wherein the fault handling process further comprises masking interrupts for the first processor cluster.

Clause 15: The processing system of Clause 14, wherein the reset operation comprises resetting and clamping one or more processor cores in the first processor cluster.

Clause 16: The processing system of any one of Clause 14-15, wherein the fault handling process further comprises performing a cache clean for the processor in the first processor cluster.

Clause 17: The processing system of any one of Clause 14-16, wherein the fault handling process does not comprise resetting a central processing unit control processor (CPUCP) of the SoC.

Clause 18: The processing system of any one of Clause 14-17, wherein the fault handling process further comprises collecting a scan dump.

Clause 19: The processing system of any one of Clause 14-18, wherein the fault handling process further comprises resetting power control for the first processor cluster and not for the second processor cluster.

Clause 20: An apparatus, comprising: means for determining a fault associated with a processor in a first processor cluster of a system on chip (SoC) comprising the first processor cluster and a second processor cluster; means for, without resetting the SoC, performing, based on the fault, a fault handling process comprising: halting processors running in the first processor cluster; performing a reset operation for at least a portion of the first processor cluster; and resuming the processors that were halted in the first processor cluster; and means for, after performing the fault handling process, performing one or more actions using the processor in the first processor cluster.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for system fault handling, comprising:
determining a fault associated with a processor in a first processor cluster of a system on chip (SoC) comprising the first processor cluster and a second processor cluster;
without resetting the SoC, performing, based on the fault, a fault handling process comprising:
halting processors running in the first processor cluster;
performing a reset operation for at least a portion of the first processor cluster; and
resuming the processors that were halted in the first processor cluster; and
after performing the fault handling process, performing one or more actions using the processor in the first processor cluster.

2. The method of claim 1, wherein the fault comprises a processor hang event, and wherein the fault handling process further comprises masking interrupts for the first processor cluster.

3. The method of claim 2, wherein the reset operation comprises resetting and clamping one or more processor cores in the first processor cluster.

4. The method of claim 2, wherein the fault handling process further comprises performing a cache clean for the processor in the first processor cluster.

5. The method of claim 2, wherein the fault handling process does not comprise resetting a central processing unit control processor (CPUCP) of the SoC.

6. The method of claim 2, wherein the fault handling process further comprises collecting a scan dump.

7. The method of claim 2, wherein the fault handling process further comprises resetting power control for the first processor cluster and not for the second processor cluster.

8. The method of claim 2, wherein the fault handling process further comprises migrating run queue tasks and interrupts away from the first processor cluster.

9. The method of claim 2, wherein the fault handling process further comprises marking one or more cores of the first processor cluster as offline.

10. The method of claim 2, wherein the fault handling process further comprises notifying an operating system (OS) scheduler for the first processor cluster that the fault handling process is being performed.

11. The method of claim 10, wherein the fault handling process further comprises notifying the OS scheduler for the first processor cluster that the reset operation is complete.

12. The method of claim 1, wherein the fault comprises a firmware fault, and wherein the reset operation comprises executing a firmware reset in the first processor cluster.

13. A processing system comprising:
one or more memories comprising processor-executable instructions; and
one or more processors configured to execute the processor-executable instructions and cause the processing system to:
determine a fault associated with a processor in a first processor cluster of a system on chip (SoC) comprising the first processor cluster and a second processor cluster;
without resetting the SoC, performing, based on the fault, a fault handling process comprising:
halt processors running in the first processor cluster;
perform a reset operation for at least a portion of the first processor cluster; and
resume the processors that were halted in the first processor cluster; and
after performing the fault handling process, perform one or more actions using the processor in the first processor cluster.

14. The processing system of claim 13, wherein the fault comprises a processor hang event, and wherein the fault handling process further comprises masking interrupts for the first processor cluster.

15. The processing system of claim 14, wherein the reset operation comprises resetting and clamping one or more processor cores in the first processor cluster.

16. The processing system of claim 14, wherein the fault handling process further comprises performing a cache clean for the processor in the first processor cluster.

17. The processing system of claim 14, wherein the fault handling process does not comprise resetting a central processing unit control processor (CPUCP) of the SoC.

18. The processing system of claim 14, wherein the fault handling process further comprises collecting a scan dump.

19. The processing system of claim 14, wherein the fault handling process further comprises resetting power control for the first processor cluster and not for the second processor cluster.

20. An apparatus, comprising:
means for determining a fault associated with a processor in a first processor cluster of a system on chip (SoC) comprising the first processor cluster and a second processor cluster;
means for, without resetting the SoC, performing, based on the fault, a fault handling process comprising:
halting processors running in the first processor cluster;
performing a reset operation for at least a portion of the first processor cluster; and
resuming the processors that were halted in the first processor cluster; and
means for, after performing the fault handling process, performing one or more actions using the processor in the first processor cluster.
